(19) United States
(12) Patent Application Publication
(10) Pub. No.: US 2024/0178502 A1
(43) Pub. Date: May 30, 2024

(54) LARGE ASPECT RATIO ELECTROCHEMICAL CELL MODULES, AND METHODS OF PRODUCING THE SAME

(71) Applicant: 24M Technologies, Inc., Cambridge, MA (US)

(72) Inventors: Naoki Ota, Lexington, MA (US); Junzheng Chen, Concord, MA (US); Mark Young, Lapel, IN (US); Chad Alan Hartzog, Columbus, OH (US); Ryan Michael Lawrence, Watertown, MA (US); Kelly B. Ledbetter, Carmel, IN (US); Khosrow Nematollahi, Carmel, IN (US)

(21) Appl. No.: 18/519,797

(22) Filed: Nov. 27, 2023

Related U.S. Application Data
(60) Provisional application No. 63/428,210, filed on Nov. 28, 2022.

(51) Int. Cl. H01M 50/264; H01M 50/211; H01M 50/291

(52) U.S. Cl. CPC H01M 50/264; H01M 50/211; H01M 50/291

(57) ABSTRACT

Embodiments described herein relate to electrochemical cell assemblies with structural members for application of compressive force. In some aspects, an electrochemical cell assembly can include a plurality of electrochemical cells arranged in a stack, a first planar sheet in contact with a first side of the stack, a second planar sheet in contact with a second side of the stack, a first structural member in compressive contact with the first planar sheet, and a second structural member in compressive contact with the second planar sheet, wherein the compressive contact between the first structural member and the first planar sheet and the compressive contact between the second structural member and the second planar sheet collectively provide structural rigidity to the electrochemical cell assembly.

### CROSS-REFERENCE TO RELATED APPLICATIONS

This application claims the benefit of U.S. Provisional Application No. 63/428,210, titled “Large Aspect Ratio Electrochemical Cell Modules, and Methods of Producing the Same,” and filed Nov. 28, 2022, the content of which is incorporated herein by reference in its entirety.

### TECHNICAL FIELD

Embodiments described herein relate to design of large format, high density modules and packs for electrochemical cell systems.

### BACKGROUND

Existing cell technology has several limitations when it comes to the size of the cells. These limitations are related to the even application of pressure across large format, low aspect ratio cells. Performance issues arise from uneven application of pressure in such cells. Smoothing out such pressure distribution can address these issues.

### SUMMARY

Embodiments described herein relate to electrochemical cell assemblies with structural members for application of compressive force. In some aspects, an electrochemical cell assembly can include a plurality of electrochemical cells arranged in a stack, a first planar sheet in contact with a first side of the stack, a second planar sheet in contact with a second side of the stack, a first structural member in compressive contact with the first planar sheet, and a second structural member in compressive contact with the second planar sheet, wherein the compressive contact between the first structural member and the first planar sheet and the compressive contact between the second structural member and the second planar sheet collectively provide structural rigidity to the electrochemical cell assembly. In some embodiments, the first structural member and the second structural member can include pressure plates with nubs that impart a compressive force on the first planar sheet and the second planar sheet. In some embodiments, the nubs have a first length at a location near a horizontal center of the electrochemical cell stack and a second length at a location near a horizontal edge of the electrochemical cell stack, the first length greater than the second length.

### BRIEF DESCRIPTION OF THE DRAWINGS

FIG. 1 is a block diagram of an electrochemical cell assembly, according to an embodiment.

FIG. 2 is an illustration of an electrochemical cell stack, according to an embodiment.

FIG. 3 is an illustration of an electrochemical cell assembly, according to an embodiment.

FIGS. 4A-4B are illustrations of an electrochemical cell assembly and the formation thereof, according to an embodiment.

FIGS. 5A-5D are illustrations of an electrochemical cell assembly and the formation thereof, according to an embodiment.

FIGS. 6A-6B are illustrations of an electrochemical cell assembly, according to an embodiment.

FIGS. 7A-7C are illustrations of an electrochemical cell assembly, according to an embodiment.

FIG. 8 is an illustration of an electrochemical cell assembly, according to an embodiment.

FIGS. 9A-9D are illustrations of an electrochemical cell assembly, according to an embodiment.

### DETAILED DESCRIPTION

Embodiments described herein relate to fabrication of large format electrochemical cells with low length-to-width aspect ratios. Such electrochemical cells can be used to build large, high energy density electrochemical cell modules. Large format low aspect ratio modules can have a relatively high energy density and are effective for heat dissipation. Electrochemical cell modules described herein include structural members to allow for cell compression. The structural members contact planar sheets to distribute force evenly along the length and width of an electrochemical cell stack. Even distribution of force along the length and width of a stack of electrochemical cells can ensure that the cells function as intended and improve heat dissipation via enhanced thermal contact.

In some embodiments, the electrochemical cell assemblies described herein can be positioned in close contact with a heat exchange device. In some embodiments, the heat exchange device can include plates and pathways for movement of a heat exchange fluid (e.g., air, liquid). In some embodiments, the heat exchange device can include dimples for turbulization of the heat exchange fluid. In some embodiments, the dimples can be the same or substantially similar to the dimples described in U.S. Provisional Patent Application No. 63/416,774, filed Oct. 17, 2022, titled “Heat Transfer Plates in Electrochemical Cell Systems, and Methods of Producing the Same,” the disclosure of which is hereby incorporated by reference in its entirety.

In some embodiments, electrochemical cell assemblies described herein can be included in an automobile. In some embodiments, the electrochemical cell assemblies can be incorporated into the structure of the automobile. In some embodiments, the electrochemical cell assemblies described herein can be self-supporting with little or no additional supporting structure. In some embodiments, electrochemical cells described herein can include spacers for integrated cooling. In some embodiments, electrochemical cells described herein can include hermetically sealed electrochemical cells allowing for the use of a non-sealed enclosure for an electrochemical cell stack. In some embodiments, air handling in cooling systems need not be IP67 waterproof rated. In some embodiments, cooling features can be included into the electrochemical cell assembly structure.

In some embodiments, the electrochemical cell assembly can include a module to provide cell compression. In some embodiments, the electrochemical cell assembly can include stiffener ribs, a preloaded compression bar, a progressive clamping and nub feature, and/or a pressure bladder. The design of the electrochemical cell assembly can allow for efficient air cooling, reducing sealing overhead with a smaller volume sealed area. In some embodiments, ambient air cooling can be used. In some embodiments, compression devices included in the electrochemical cell assembly can include compression devices that nest into opposing void areas. Compression devices can provide channels for cooling media. In some embodiments, module connections can support multiple modular connections. In some embodiments, vehicle structure can provide at least a portion of the compressive force provided to the electrochemical cell assembly, limiting module cost.

In some embodiments, electrochemical cells described herein can include anodes and cathodes, with separators disposed therebetween. In some embodiments, electrochemical cells described herein can include pouches, as described in U.S. Pat. No. 10,181,587 (“the '587 patent”), filed Jun. 17, 2016, titled, “Single Pouch Battery Cells and Methods of Manufacture,” the disclosure of which is hereby incorporated by reference in its entirety. In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

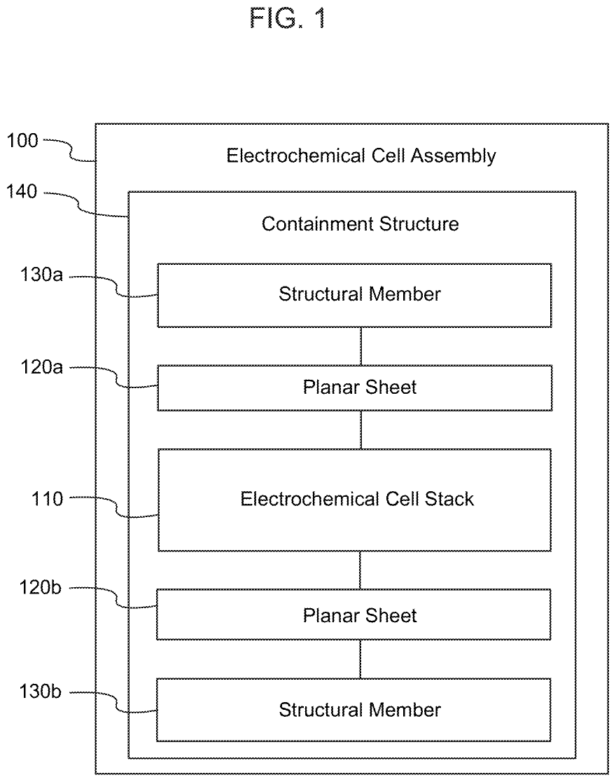

FIG. 1 is a block diagram of an electrochemical cell system 100, according to an embodiment. As shown, the electrochemical cell system 100 includes an electrochemical cell stack 110, a first planar sheet 120a and a second planar sheet 120b (collectively referred to as planar sheets 120) disposed on either side of the electrochemical cell stack 110, and a first structural member 130a and a second structural member 130b (collectively referred to as structural members 130) disposed on either side of the planar sheets 120. The electrochemical cell assembly 100 further includes a containment structure 140 containing the electrochemical cell stack 110, the planar sheets 120, and the structural members 130.

In some embodiments, the electrochemical cells in the electrochemical cell stack 110 can be the same or substantially similar to the electrochemical cells described in the '587 patent. Each of the electrochemical cells can include an anode material disposed on an anode current collector, a cathode material disposed on a cathode current collector, and a separator disposed between the anode material and the cathode material. In some embodiments, the separator can be large enough that a portion of the separator extends beyond an outer edge of the anode material and an outer edge of the cathode material. The electrochemical cells can further include a pouch material at least partially encasing the anode material, the anode current collector, the cathode material, the cathode current collector, and the separator. In some embodiments, the pouch material can contact the anode current collector, the cathode current collector, and/or the separator. The pouch material can be large enough that a portion of the pouch material extends beyond an outer bound of the separator.

The electrochemical cell stack 110 includes multiple electrochemical cells arranged in a stack. In some embodiments, the electrochemical cell stack 110 can include at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 150, at least about 200, at least about 250, at least about 300, at least about 350, at least about 400, at least about 450 electrochemical cells. In some embodiments, the electrochemical cell stack 110 can include no more than about 500, no more than about 450, no more than about 400, no more than about 350, no more than about 300, no more than about 250, no more than about 200, no more than about 150, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 electrochemical cells. Combinations of the above-referenced numbers of electrochemical cells are also possible (e.g., at least about 1 electrochemical cell and no more than about 500 electrochemical cells or at least about 5 electrochemical cells and no more than about 50 electrochemical cells), inclusive of all values and ranges therebetween. In some embodiments, the electrochemical cell stack 110 can include about 1, about 2, about 3, about 4, about 5, about 6, about 7, about 8, about 9, about 10, about 20, about 30, about 40, about 50, about 60, about 70, about 80, about 90, about 100, about 150, about 200, about 250, about 300, about 350, about 400, about 450, or about 500 electrochemical cells. In some embodiments, the electrochemical cell stack 110 can be sectioned into subgroups of electrochemical cells with thermal spacers between each subgroup. In some embodiments, each subgroup shares the same set of restraining hardware.

The planar sheets 120 aid in evenly distributing force on the outside surfaces of the electrochemical cell stack 110. In some embodiments, the planar sheets 120 can have the same or substantially similar length and width dimensions to the electrochemical cell stack 110. In some embodiments, the planar sheets 120 can have a slightly larger length and a slightly larger width than the electrochemical cells in the electrochemical cell stack 110, such that the planar sheets 120 can wrap around the electrochemical cell stack 110. In some embodiments, the planar sheets 120 can be composed of a metal (e.g., aluminum, stainless steel, high-strength low-allow steel). In some embodiments, the planar sheets 120 can be composed of a polymer (e.g., polyethylene, polypropylene). In some embodiments, the planar sheets 120 can be composed of a ceramic, alumina, carbide, a composite, a glass-filled plastic, a carbon fiber, or any combination thereof. In some embodiments, the electrochemical cell assembly 100 can include a compliant material (not shown) on a surface of the electrochemical cell stack 110 as a means of evenly distributing pressure. In some embodiments, the compliant material can include a foam, a rubber, or any combination thereof.

The structural members 130 press against the planar sheets 120. In some embodiments, the structural members 130 can include leaf springs. In some embodiments, the structural members 130 can include inflatable bladders. In some embodiments, the structural members 130 can include stiffener ribs. In some embodiments, the structural members 130 can include preloaded compression bars. In some embodiments, the structural members 130 can include a progressive clamp. In some embodiments, the structural members 130 can include nubs for imparting force on the planar sheets 120.

The containment structure 140 keeps the electrochemical cell stack 110, the planar sheets 120, and the structural members 130 contained. In some embodiments, the containment structure 140 can contact the structural members 130. In some embodiments, the structural members 130 can be contained in the containment structure 140, such that an internal load is created by the interaction between the structural members 130 and the containment structure 140. In some embodiments, the containment structure 140 can include a cell casing, the same or substantially similar to the casings described in the '587 patent.

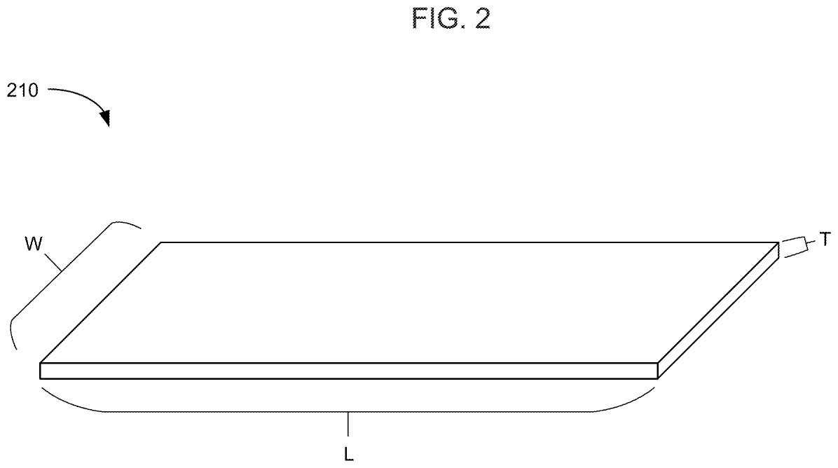

FIG. 2 is an illustration of an electrochemical cell stack 210, according to an embodiment. In some embodiments, the electrochemical cell stack 210 can be the same or substantially similar to the electrochemical cell stack 110, as described above with reference to FIG. 1. Thus, certain aspects of the electrochemical cell stack 210 are not described in greater detail herein.

As shown, the electrochemical cell stack 210 has a length L, a width W, and a thickness T. As shown, the thickness T of the electrochemical cell stack 210 is the vertical dimension along which the electrochemical cells are stacked. As shown, the length L is the longer of the two dimensions describing the breadth of the electrochemical cells in the electrochemical cell stack 210 and the width W is the shorter of the two dimensions describing the breadth of the electrochemical cells in the electrochemical cell stack 210.

In some embodiments, the length L of the electrochemical cell stack 210 can be at least about 5 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 1.5 m, at least about 2 m, at least about 2.5 m, at least about 3 m, at least about 3.5 m, at least about 4 m, or at least about 4.5 m. In some embodiments, the length L of the electrochemical cell stack 210 can be no more than about 5 m, no more than about 4.5 m, no more than about 4 m, no more than about 3.5 m, no more than about 3 m, no more than about 2.5 m, no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, or no more than about 1 cm. Combinations of the above-referenced lengths are also possible (e.g., at least about 5 mm and no more than about 5 m or at least about 5 cm and no more than about 40 cm), inclusive of all values and ranges therebetween. In some embodiments, the length L of the electrochemical cell stack 210 can be about 5 mm, about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 1.5 m, about 2 m, about 2.5 m, about 3 m, about 3.5 m, about 4 m, about 4.5 m, or about 5 m.

In some embodiments, the width W can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, or at least about 1.5 m. In some embodiments, the width W can be no more than about 2 m, no more than about 1.5 m, no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced widths are also possible (e.g., at least about 1 mm and no more than about 2 m or at least about 5 cm and no more than about 30 cm), inclusive of all values and ranges therebetween. In some embodiments, the width W can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 1.5 m, or about 2 m.

In some embodiments, the thickness T can be at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, or at least about 19 cm. In some embodiments, the thickness T can be no more than about 20 cm, no more than about 19 cm, no more than about 18 cm, no more than about 17 cm, no more than about 16 cm, no more than about 15 cm, no more than about 14 cm, no more than about 13 cm, no more than about 12 cm, no more than about 11 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, or no more than about 300 μm. Combinations of the above-referenced thicknesses are also possible (e.g., at least about 200 μm and no more than about 20 cm or at least about 1 mm and no more than about 2 cm), inclusive of all values and ranges therebetween. In some embodiments, the thickness T can be about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, or about 20 cm.

Large format cells with large aspect ratios (i.e., ratios of length L to thickness T or width W to thickness T) can aid in heat dissipation from the electrochemical cell stack 210. In some embodiments, the ratio of the length L to the thickness T of the electrochemical cell stack 210 can be at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, or at least about 1,000. In some embodiments, the ratio of the width W to the thickness T of the electrochemical cell stack 210 can be at least about 1.5, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, or at least about 800.

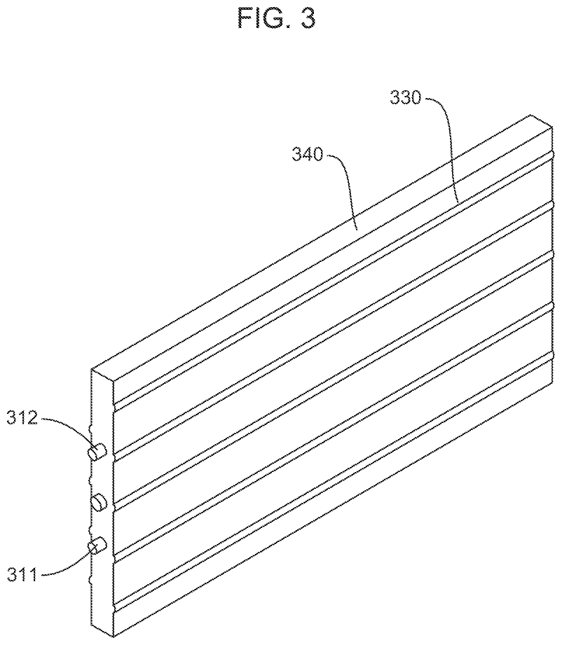

FIG. 3 shows an electrochemical cell assembly 300, according to an embodiment. The electrochemical cell assembly 300 includes an electrochemical cell stack (not shown) with planar sheets (not shown) disposed inside of a containment structure 340 with structural members 330 integrated into the containment structure 340. As shown, the electrochemical cell assembly 300 includes a common anode tab 311 in electrical contact with a plurality of anode tabs (not shown) and a common cathode tab 312 in electrical contact with a plurality of cathode tabs (not shown).

As shown, the structural members 330 include stiffener ribs integrated into the containment structure 340. In some embodiments, the structural members 330 can be bent in their natural, relaxed state, and can be flattened when integrated into the containment structure 340. The bending of the structural members 330 can create an internal load, such that the structural members 330 apply a pressure to the planar sheets and the electrochemical cell stack. As shown, the electrochemical cell assembly 300 includes 5 stiffener ribs on a first side of the electrochemical cell assembly 300 and 4 stiffener ribs on a second side of the electrochemical cell assembly 300 opposite the first side. As shown, the stiffener ribs on the first side are offset from the stiffener ribs on the second side. Such an arrangement can allow multiple electrochemical cell assemblies to stack and nest against each other. In some embodiments, the stiffener ribs can be arranged parallel to each other. In some embodiments, the electrochemical cell assembly 300 can include about 2, about 3, about 4, about 5, about 6, about 7, about 8, about 9, about 10, about 20, about 30, about 40, about 50, about 60, about 70, about 80, about 90, or about 100 stiffener ribs on either side of the electrochemical cell assembly 300, inclusive of all values and ranges therebetween.

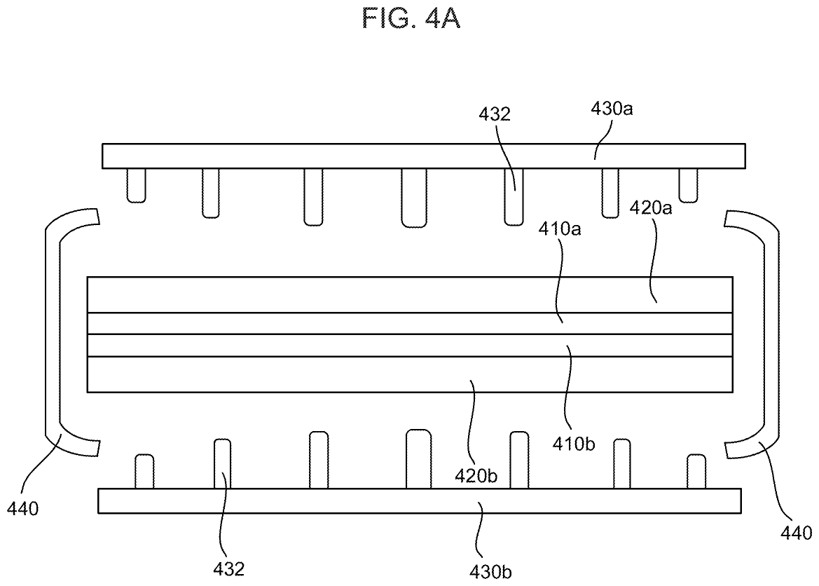

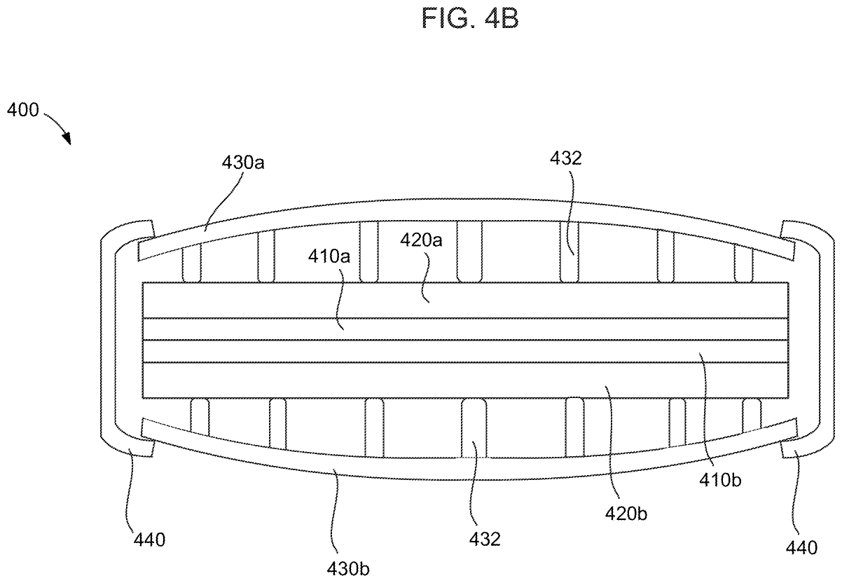

FIGS. 4A-4B show the formation of an electrochemical cell assembly 400. As shown, the electrochemical cell assembly 400 includes electrochemical cells 410a, 410b (collectively referred to as electrochemical cell stack 410), planar sheets 420a, 420b (collectively referred to as planar sheets 420), structural members 430a, 430b (collectively referred to as structural members 430) with nubs 432, and containment structures 440. In some embodiments, the electrochemical cell stack 410, the planar sheets 420, the structural members 430, and the containment structure 440 can be the same or substantially similar to the electrochemical cell stack 110, the planar sheets 120, the structural members 430, and the containment structure 140, as described above with reference to FIG. 1. Thus, certain aspects of the electrochemical cell stack 410, the planar sheets 420, the structural members 430, and the containment structure 440 are not described in greater detail herein. FIG. 4A shows the components of the electrochemical cell assembly 400 separate from each other, while FIG. 4B shows the fully-formed electrochemical cell assembly 400.

In some embodiments, the planar sheets 420 can each have a thickness the same or substantially similar to the thickness of the electrochemical cell stack 410. In some embodiments, the planar sheets 420 can each have a thickness less than the thickness of the electrochemical cell stack 410. In some embodiments, the planar sheets 420 can each have a thickness greater than the thickness of the electrochemical cell stack 410. In some embodiments, the planar sheet 420a and the planar sheet 420b can each have the same or substantially similar thicknesses. In some embodiments, the planar sheet 420a can have a different thickness from the planar sheet 420b.

In some embodiments, the planar sheet 420a and/or the planar sheet 420b can have a thickness of at least about 100 μm, at least about 200 μm, at least about 400 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, or at least about 4 cm. In some embodiments, the planar sheet 420a and/or the planar sheet 420b can have a thickness of no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 400 μm, or no more than about 200 μm. Combinations of the above-referenced thicknesses are also possible (e.g., at least about 100 μm and no more than about 5 cm or at least about 1 mm and no more than about 8 mm), inclusive of all values and ranges therebetween. In some embodiments, the planar sheet 420a and/or the planar sheet 420b can have a thickness of about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, or about 5 cm.

As shown, the structural members 430 include pressure plates with nubs 432 that are longer near the horizontal center of the electrochemical cell stack 410 than the edges of the electrochemical cell stack 410. The profile of the nubs 432 can be chosen to offset the displacement of the planar portions of the structural members 430 under load. When under force (i.e., via the containment structure 440), the nubs 432 are in contact with the planar sheets 420. The planar sheets 420 distribute the force imposed by the nubs 432. As shown, the nubs 432 have a rounded distal end. In some embodiments, the nubs 432 can be parts of the same piece of material as the structural members 430. In some embodiments, the nubs 432 can be bonded to the structural members 430 (e.g., via an adhesive). In some embodiments, the nubs 432 can be composed of a polymer, a vulcanized rubber, aluminum, steel, ceramic, composite, or any combination thereof.

As shown, the structural members 430 each include 7 nubs 432. In some embodiments, the structural members 430 can each include at least about 3, at least about 4, at least about 5, at least about 6, at least about 7, at least about 8, at least about 9, at least about 10, at least about 15, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, or at least about 95 nubs 432. In some embodiments, the structural members 430 can each include no more than about 100, no more than about 95, no more than about 90, no more than about 85, no more than about 80, no more than about 75, no more than about 70, no more than about 65, no more than about 60, no more than about 55, no more than about 50, no more than about 45, no more than about 40, no more than about 35, no more than about 30, no more than about 25, no more than about 20, no more than about 15, no more than about 10, no more than about 9, no more than about 8, no more than about 7, no more than about 6, no more than about 5, or no more than about 4 nubs 432. Combinations of the above-referenced numbers of nubs 432 are also possible (e.g., at least about 3 nubs 432 and no more than about 100 nubs 432 or at least about 5 nubs 432 and no more than about 15 nubs 432. In some embodiments, the structural members 430 can each include about 3, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, or about 100 nubs 432.

In some embodiments, the nubs 432 can be arranged along a plane of the structural members 430 in a m×n pattern. In some embodiments, m and/or n can be about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, or about 25. In some embodiments, the nubs 432 can be wide, such that they extend along the length or the width of the structural members 430. In other words, the nubs 432 can extend along the dimension that goes into and out of the page in FIGS. 4A and 4B. In some embodiments, the nubs 432 can have a width of about 10%, about 20%, about 30%, about 40%, about 50%, about 60%, about 70%, about 80%, about 90%, about 95%, or about 100% of the width or the length of the structural members 430.

As shown, starting from the edge of the electrochemical cell stack 410, the nubs 432 become successively longer, until they reach a maximum length near the horizontal center of the electrochemical cell stack 410. In some embodiments, the nubs 432 can have a length of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the nubs 432 can have a length of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 400 μm, or no more than about 200 μm. Combinations of the above-referenced lengths of the nubs 432 are also possible (e.g., at least about 100 μm and no more than about 10 cm or at least about 5 mm and no more than about 2 cm), inclusive of all values and ranges therebetween. In some embodiments, the nubs 432 can have a length of about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, a ratio of the length of the longest of the nubs 432 (i.e., near the horizontal center of the electrochemical cell stack 410) and the shortest of the nubs 432 (i.e., near the outer edge of the electrochemical cell stack 410) can be at least about 1.5:1, at least about 1.6:1, at least about 1.7:1, at least about 1.8:1, at least about 1.9:1, at least about 2:1, at least about 2.5:1, at least about 3:1, at least about 3.5:1, at least about 4:1, at least about 4.5:1, at least about 5:1, at least about 6:1, at least about 7:1, at least about 8:1, at least about 9:1, at least about 10:1, at least about 20:1, at least about 30:1, or at least about 40:1. In some embodiments, the ratio of the length of the longest of the nubs 432 to the shortest of the nubs 432 can be no more than about 50:1, no more than about 40:1, no more than about 30:1, no more than about 20:1, no more than about 10:1, no more than about 9:1, no more than about 8:1, no more than about 7:1, no more than about 6:1, no more than about 5:1, no more than about 4:1, no more than about 3:1, no more than about 2:1,no more than about 1.9:1, no more than about 1.8:1, no more than about 1.7:1, or no more than about 1.6:1. Combinations of the above-referenced length ratios are also possible (e.g., at least about 1.5:1 and no more than about 50:1 or at least about 5:1 and no more than about 20:1), inclusive of all values and ranges therebetween. In some embodiments, a ratio of the length of the longest of the nubs 432 and the shortest of the nubs 432 can be about 1.5:1, about 1.6:1, about 1.7:1, about 1.8:1, about 1.9:1, about 2:1, about 2.5:1, about 3:1, about 3.5:1, about 4:1, about 4.5:1, about 5:1, about 6:1, about 7:1, about 8:1, about 9:1, about 10:1, about 20:1, about 30:1, about 40:1, or about 50:1.

The containment structure 440 holds the structural members 430 in place against the planar sheets 420. In some embodiments, the containment structure 440 can include a single piece of material that encircles the electrochemical cell stack 410. In some embodiments, the containment structure 440 can include multiple pieces of material that each clamp to a portion of the structural members 430. In some embodiments, the containment structure 440 can be composed of a rigid material. In some embodiments, the containment structure 440 can be composed of a flexible material. In some embodiments, the containment structure 440 can be composed of a material with having a modulus of elasticity greater than or equal to that of structural steel. In some embodiments, the containment structure 440 can be composed of other high strength materials, including metals or alloys In some embodiments, the containment structure 440 can be composed of the same material as the structural members 430. As shown, the structural members 430 tuck under ridges of the containment structure 440 to secure in place. In some embodiments, the containment structure 440 can be bonded to the structural members 430 (e.g., via an adhesive). In some embodiments, the containment structure 440 can secure to the structural members 430 via a latch (not shown).

In some embodiments, the structural members 430 can press the planar sheets 420 with a force of at least about 1 N, at least about 2 N, at least about 3 N, at least about 4 N, at least about 5 N, at least about 6 N, at least about 7 N, at least about 8 N, at least about 9 N, at least about 10 N, at least about 20 N, at least about 30 N, at least about 40 N, at least about 50 N, at least about 60 N, at least about 70 N, at least about 80 N, at least about 90 N, at least about 100 N, at least about 200 N, at least about 300 N, at least about 400 N, at least about 500 N, at least about 600 N, at least about 700 N, at least about 800 N, at least about 900 N, at least about 1,000 N, at least about 2,000 N, at least about 3,000 N, at least about 4,000 N, at least about 5,000 N, at least about 6,000 N, at least about 7,000 N, at least about 8,000 N, at least about 9,000 N, at least about 10,000 N, at least about 20,000 N, at least about 30,000 N, at least about 40,000 N, at least about 50,000 N, at least about 60,000 N, at least about 70,000 N, at least about 80,000 N, at least about 90,000 N, at least about 100,000 N, at least about 200,000 N, at least about 300,000 N, at least about 400,000 N, at least about 500,000 N, at least about 600,000 N, at least about 700,000 N, at least about 800,000 N, or at least about 900,000 N. In some embodiments, the structural members 430 can press the planar sheets 420 with a force of no more than about 1,000,000 N, no more than about 900,000 N, no more than about 800,000 N, no more than about 700,000 N, no more than about 600,000 N, no more than about 500,000 N, no more than about 400,000 N, no more than about 300,000 N, no more than about 200,000 N, no more than about 100,000 N, no more than about 90,000 N, no more than about 80,000 N, no more than about 70,000 N, no more than about 60,000 N, no more than about 50,000 N, no more than about 40,000 N, no more than about 30,000 N, no more than about 20,000 N, no more than about 10,000 N, no more than about 9,000 N, no more than about 8,000 N, no more than about 7,000 N, no more than about 6,000 N, no more than about 5,000 N, no more than about 4,000 N, no more than about 3,000 N, no more than about 2,000 N, no more than about 1,000 N, no more than about 900 N, no more than about 800 N, no more than about 700 N, no more than about 600 N, no more than about 500 N, no more than about 400 N, no more than about 300 N, no more than about 200 N, no more than about 100 N, no more than about 90 N, no more than about 80 N, no more than about 70 N, no more than about 60 N, no more than about 50 N, no more than about 40 N, no more than about 30 N, no more than about 20 N, no more than about 10 N, no more than about 9 N, no more than about 8 N, no more than about 7 N, no more than about 6 N, no more than about 5 N, no more than about 4 N, no more than about 3 N, or no more than about 2 N. Combinations of the above-referenced forces are also possible (e.g., at least about 1 N and no more than about 1,000,000 N or at least about 20 N and no more than about 200 N), inclusive of all values and ranges therebetween. In some embodiments, the structural members 430 can press the planar sheets 420 with a force of about 1 N, about 2 N, about 3 N, about 4 N, about 5 N, about 6 N, about 7 N, about 8 N, about 9 N, about 10 N, about 20 N, about 30 N, about 40 N, about 50 N, about 60 N, about 70 N, about 80 N, about 90 N, about 100 N, about 200 N, about 300 N, about 400 N, about 500 N, about 600 N, about 700 N, about 800 N, about 900 N, about 1,000 N, about 2,000 N, about 3,000 N, about 4,000 N, about 5,000 N, about 6,000 N, about 7,000 N, about 8,000 N, about 9,000 N, about 10,000 N, about 20,000 N, about 30,000 N, about 40,000 N, about 50,000 N, about 60,000 N, about 70,000 N, about 80,000 N, about 90,000 N, about 100,000 N, about 200,000 N, about 300,000 N, about 400,000 N, about 500,000 N, about 600,000 N, about 700,000 N, about 800,000 N, about 900,000 N, about 1,000,000 N.

In some embodiments, the structural members 430 can create a pressure in the electrochemical cell stack 410 of at least about 10 kPa (gauge), at least about 20 kPa, at least about 30 kPa, at least about 40 kPa, at least about 50 kPa, at least about 60 kPa, at least about 70 kPa, at least about 80 kPa, at least about 90 kPa, at least about 100 kPa, at least about 200 kPa, at least about 300 kPa, at least about 400 kPa, at least about 500 kPa, at least about 600 kPa, at least about 700 kPa, at least about 800 kPa, or at least about 900 kPa. In some embodiments, the structural members 430 can create a pressure in the electrochemical cell stack 410 of no more than about 1,000 kPa, no more than about 900 kPa, no more than about 800 kPa, no more than about 700 kPa, no more than about 600 kPa, no more than about 500 kPa, no more than about 400 kPa, no more than about 300 kPa, no more than about 200 kPa, no more than about 100 kPa, no more than about 90 kPa, no more than about 80 kPa, no more than about 70 kPa, no more than about 60 kPa, no more than about 50 kPa, no more than about 40 kPa, no more than about 30 kPa, or no more than about 20 kPa. Combinations of the above-referenced pressures are also possible (e.g., at least about 10 kPa and no more than about 1,000 kPa or at least about 50 kPa and no more than about 500 kPa), inclusive of all values and ranges therebetween. In some embodiments, the structural members 430 can create a pressure in the electrochemical cell stack 410 of about 10 kPa, about 20 kPa, about 30 kPa, about 40 kPa, about 50 kPa, about 60 kPa, about 70 kPa, about 80 kPa, about 90 kPa, about 100 kPa, about 200 kPa, about 300 kPa, about 400 kPa, about 500 kPa, about 600 kPa, about 700 kPa, about 800 kPa, about 900 kPa, or about 1,000 kPa.

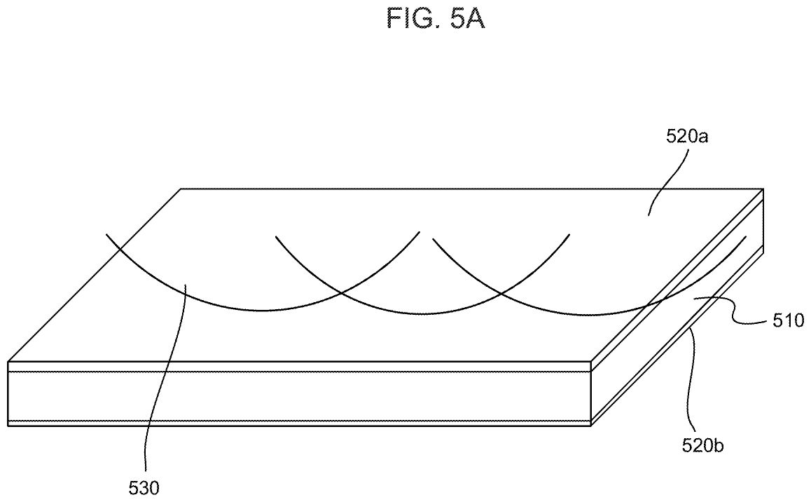

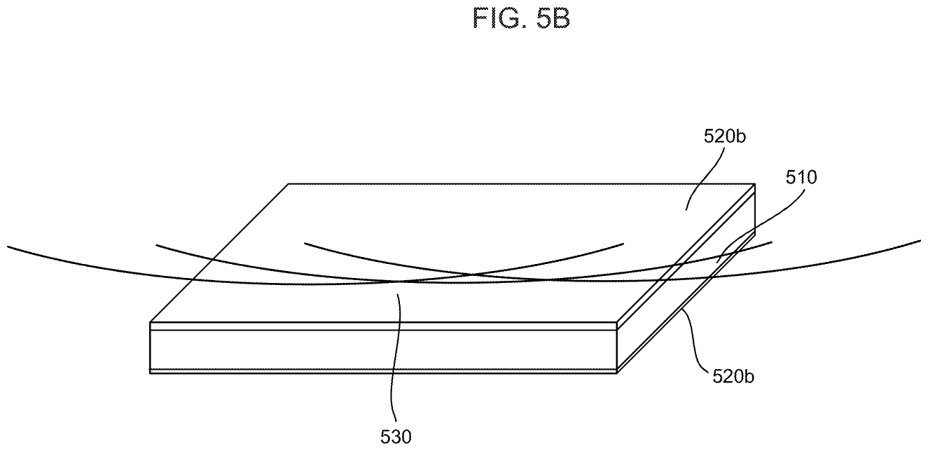

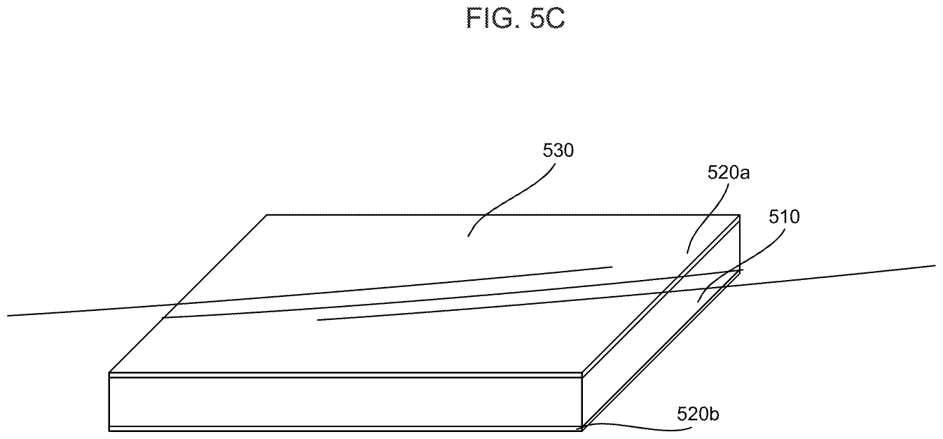

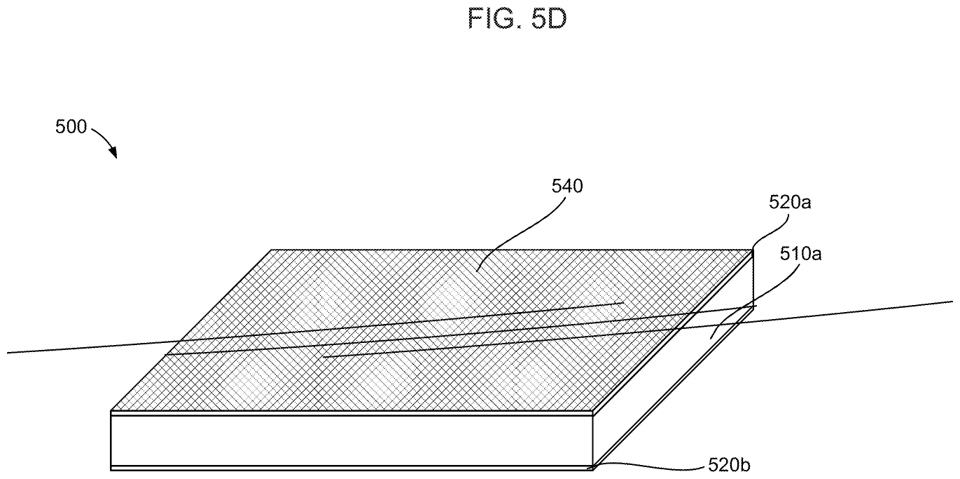

FIG. 5A-5D show formation of an electrochemical cell assembly 500, according to an embodiment. As shown, the electrochemical cell assembly 500 includes an electrochemical cell stack 510, planar sheets 520a, 520b (collectively referred to as planar sheets 520), structural members 530, and a containment structure 540. In some embodiments, the electrochemical cell stack 510, the planar sheets 520, the structural members 530, and the containment structure 540 can be the same or substantially similar to the electrochemical cell stack 110, the planar sheets 120, the structural members 130, and the containment structure 140, as described above with reference to FIG. 1. Thus, certain aspects of the electrochemical cell stack 510, the planar sheets 520, the structural members 530, and the containment structure 540 are not described in greater detail herein.

As shown, the structural members 530 are preloaded straps, akin to leaf springs. The structural members 530 are in a curved state when not under load, and a load can be applied to flatten the structural members. FIG. 5A shows the structural members 530 in a relaxed, bent state. FIG. 5B shows the structural members 530 partially flattened, and FIG. 5C shows the structural members 530 fully flattened, such that they impart a load on the planar sheet 520a and the electrochemical cell stack 510. The containment structure 540 is not shown in FIG. 5C, such that the structural members 530 can be seen. FIG. 5D shows the containment structure 540 in place. FIGS. 5A-5D show the structural members 530 only on a first side of the electrochemical cell assembly 500. In some embodiments, the structural members 530 can be placed on both sides of the electrochemical cell assembly 500 (i.e., contacting the planar sheet 520a and the planar sheet 520b).

In some embodiments, the structural members 530 can be composed of a shape memory material (e.g., nitinol, a shape memory polymer). In some embodiments, each of the structural members 530 can include a solid, continuous length of material. As shown, 3 structural members 530 are in contact with the planar sheet 520a. In some embodiments, about 1, about 2, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, about 100, or at least about 100 structural members 530 can be in contact with the planar sheet 520a and/or the planar sheet 520b, inclusive of all values and ranges therebetween.

In some embodiments, the structural members 530 can be oriented along a width dimension of the electrochemical cell stack 510. In some embodiments, the structural members 530 can be oriented along a length dimension of the electrochemical cell stack 510. In some embodiments, when flattened the structural members 530 can extend the full width or length of the electrochemical cell stack 510. In some embodiments, when flattened the structural members 530 can extend about 50%, about 55%, about 60%, about 65%, about 70%, about 75%, about 80%, about 85%, about 90%, about 95%, about 96%, about 97%, about 98%, or about 99% of the length or width of the electrochemical cell stack 510, inclusive of all values and ranges therebetween.

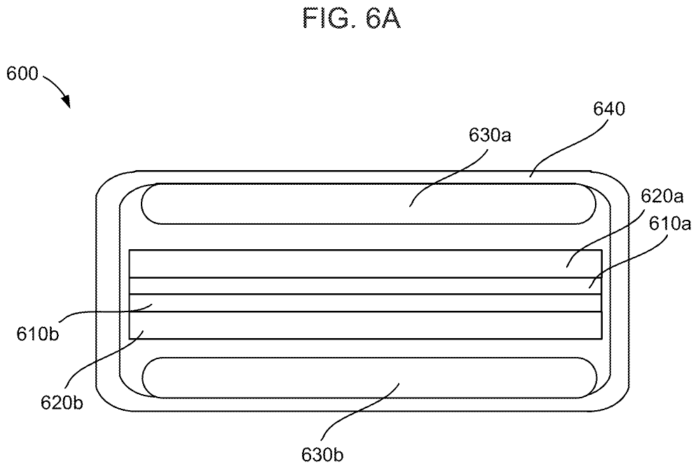

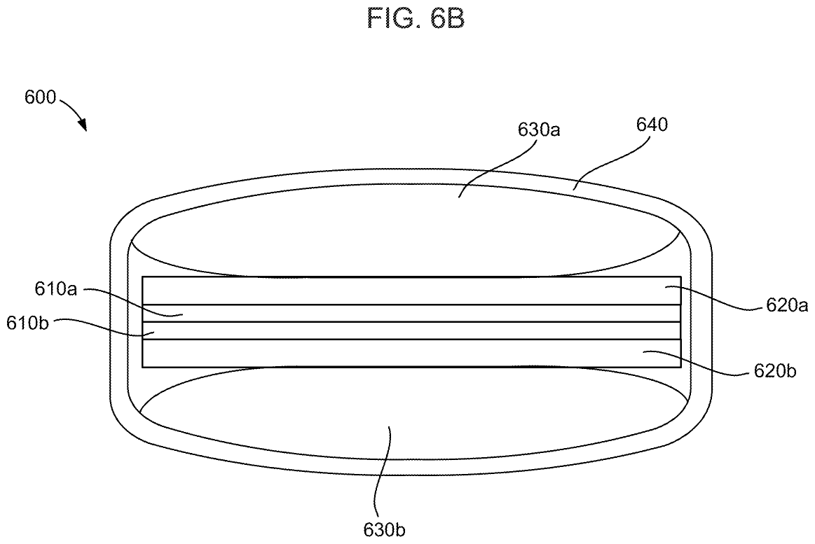

FIGS. 6A-6B show an electrochemical cell assembly 600, according to an embodiment. As shown, the electrochemical cell assembly 600 includes electrochemical cells 610a, 610b (collectively referred to as electrochemical cell stack 610), planar sheets 620a, 620b (collectively referred to as planar sheets 620), structural members 630a, 630b (collectively referred to as structural members 630), and a containment structure 640. In some embodiments, the electrochemical cell stack 610, the planar sheets 620, the structural members 630, and the containment structure 640 can be the same or substantially similar to the electrochemical cell stack 110, the planar sheets 120, the structural members 130, and the containment structure 140, as described above with reference to FIG. 1. Thus, certain aspects of the electrochemical cell stack 610, the planar sheets 620, the structural members 630, and the containment structure 640 are not described in greater detail herein.

As shown, the structural members 630 are inflatable bladders. FIG. 6A shows the structural members 630 in an uninflated state, while FIG. 6B shows the structural members 630 in an inflated state, such that the structural members 630 impart a force on the planar sheets 620. As shown, the structural members 630 deform the containment structure 640. In some embodiments, the structural members 630 can expand in size by a factor of about 1.1, about 1.2, about 1.3, about 1.4, about 1.5, about 1.6, about 1.7, about 1.8, about 1.9, about 2, about 2.5, about 3, about 3.5, about 4, about 4.5, about 5, about 5.5, about 6, about 6.5, about 7, about 7.5, about 8, about 8.5, about 9, about 9.5, or about 10, inclusive of all values and ranges therebetween. In some embodiments, the structural members 630 can be inflated pneumatically. In some embodiments, the structural members 630 can be inflated hydraulically. In some embodiments, the structural members 630 can be composed of a flexible material. In some embodiments, the structural members 630 can be composed of urethane, a vinyl-coated fabric, rubber, polyurethane, nitrile, rubber, Kevlar, nylon, polyester, neoprene, or any combination thereof. In some embodiments, the structural members 630 can be composed of metal. In some embodiments, the structural members 630 can include welded metal bellows.

In some embodiments, the structural members 630 can be pressurized to a pressure of at least about 10 kPa (gauge), at least about 20 kPa, at least about 30 kPa, at least about 40 kPa, at least about 50 kPa, at least about 60 kPa, at least about 70 kPa, at least about 80 kPa, at least about 90 kPa, at least about 100 kPa, at least about 200 kPa, at least about 300 kPa, at least about 400 kPa, at least about 500 kPa, at least about 600 kPa, at least about 700 kPa, at least about 800 kPa, or at least about 900 kPa. In some embodiments, the structural members 630 can be pressurized to a pressure of no more than about 1,000 kPa, no more than about 900 kPa, no more than about 800 kPa, no more than about 700 kPa, no more than about 600 kPa, no more than about 500 kPa, no more than about 400 kPa, no more than about 300 kPa, no more than about 200 kPa, no more than about 100 kPa, no more than about 90 kPa, no more than about 80 kPa, no more than about 70 kPa, no more than about 60 kPa, no more than about 50 kPa, no more than about 40 kPa, no more than about 30 kPa, or no more than about 20 kPa. Combinations of the above-referenced pressures are also possible (e.g., at least about 10 kPa and no more than about 1,000 kPa or at least about 50 kPa and no more than about 500 kPa), inclusive of all values and ranges therebetween. In some embodiments, the structural members 630 can be pressurized to a pressure of about 10 kPa, about 20 kPa, about 30 kPa, about 40 kPa, about 50 kPa, about 60 kPa, about 70 kPa, about 80 kPa, about 90 kPa, about 100 kPa, about 200 kPa, about 300 kPa, about 400 kPa, about 500 kPa, about 600 kPa, about 700 kPa, about 800 kPa, about 900 kPa, or about 1,000 kPa.

In some embodiments, the containment structure 640 can be flexible and can expand upon expansion of the structural members 630. In some embodiments, the containment structure 640 can have a modulus of elasticity greater than that of the structural members 630, such that the containment structure 640 expands, but limits the expansion of the structural members 630. In some embodiments, the structural members 630 can be composed of a different material than the containment structure 640. In some embodiments, the containment structure 640 can have a wall thickness greater than a wall thickness of the structural members 630. In some embodiments, the containment structure 640 can be composed of the same material as the structural members 630.

In some embodiments, the structural members 630 can have a modulus of elasticity of at least about 1 MPa, at least about 2 MPa, at least about 3 MPa, at least about 4 MPa, at least about 5 MPa, at least about 6 MPa, at least about 7 MPa, at least about 8 MPa, at least about 9 MPa, at least about 10 MPa, at least about 20 MPa, at least about 30 MPa, at least about 40 MPa, at least about 50 MPa, at least about 60 MPa, at least about 70 MPa, at least about 80 MPa, at least about 90 MPa, at least about 100 MPa, at least about 200 MPa, at least about 300 MPa, at least about 400 MPa, at least about 500 MPa, at least about 600 MPa, at least about 700 MPa, at least about 800 MPa, or at least about 900 MPa, at least about 1 GPa, at least about 5 GPa, at least about 10 GPa, at least about 50 GPa, at least about 100 GPa, at least about 200 GPa, at least about 300 GPa, or at least about 400 GPa. In some embodiments, the structural members 630 can have a modulus of elasticity of no more than about 500 GPa, no more than about 400 GPa, no more than about 300 GPa, no more than about 200 GPa, no more than about 100 GPa, no more than about 50 GPa, no more than about 10 GPa, no more than about 5 GPa, no more than about 1 GPa, no more than about 900 MPa, no more than about 800 MPa, no more than about 700 MPa, no more than about 600 MPa, no more than about 500 MPa, no more than about 400 MPa, no more than about 300 MPa, no more than about 200 MPa, no more than about 100 MPa, no more than about 90 MPa, no more than about 80 MPa, no more than about 70 MPa, no more than about 60 MPa, no more than about 50 MPa, no more than about 40 MPa, no more than about 30 MPa, no more than about 20 MPa, no more than about 10 MPa, no more than about 9 MPa, no more than about 8 MPa, no more than about 7 MPa, no more than about 6 MPa, no more than about 5 MPa, no more than about 4 MPa, no more than about 3 MPa, or no more than about 2 MPa. Combinations of the above-referenced moduli of elasticity are also possible (e.g., at least about 1 MPa and no more than about 1 GPa or at least about 50 MPa and no more than about 900 MPa), inclusive of all values and ranges therebetween. In some embodiments, the structural members 630 can have a modulus of elasticity of about 1 MPa, about 2 MPa, about 3 MPa, about 4 MPa, about 5 MPa, about 6 MPa, about 7 MPa, about 8 MPa, about 9 MPa, about 10 MPa, about 20 MPa, about 30 MPa, about 40 MPa, about 50 MPa, about 60 MPa, about 70 MPa, about 80 MPa, about 90 MPa, about 100 MPa, about 200 MPa, about 300 MPa, about 400 MPa, about 500 MPa, about 600 MPa, about 700 MPa, about 800 MPa, about 900 MPa, about 1 GPa, about 5 GPa, about 10 GPa, about 50 GPa, about 100 GPa, about 200 GPa, about 300 GPa, about 400 GPa, or about 500 GPa.

In some embodiments, the containment structure 640 can have a modulus of elasticity of at least about 10 MPa, at least about 20 MPa, at least about 30 MPa, at least about 40 MPa, at least about 50 MPa, at least about 60 MPa, at least about 70 MPa, at least about 80 MPa, at least about 90 MPa, at least about 100 MPa, at least about 200 MPa, at least about 300 MPa, at least about 400 MPa, at least about 500 MPa, at least about 600 MPa, at least about 700 MPa, at least about 800 MPa, at least about 900 MPa, at least about 1 GPa, at least about 2 GPa, at least about 3 GPa, at least about 4 GPa, at least about 5 GPa, at least about 6 GPa, at least about 7 GPa, at least about 8 GPa, at least about 9 GPa, at least about 10 GPa, at least about 50 GPa, at least about 100 GPa, at least about 200 GPa, at least about 300 GPa, or at least about 400 GPa. In some embodiments, the structural members 630 can have a modulus of elasticity of no more than about 500 GPa, no more than about 400 GPa, no more than about 300 GPa, no more than about 200 GPa, no more than about 100 GPa, no more than about 50 GPa, no more than about 10 GPa, no more than about 9 GPa, no more than about 8 GPa, no more than about 7 GPa, no more than about 6 GPa, no more than about 5 GPa, no more than about 4 GPa, no more than about 3 GPa, no more than about 2 GPa, no more than about 1 GPa, no more than about 900 MPa, no more than about 800 MPa, no more than about 700 MPa, no more than about 600 MPa, no more than about 500 MPa, no more than about 400 MPa, no more than about 300 MPa, no more than about 200 MPa, no more than about 100 MPa, no more than about 90 MPa, no more than about 80 MPa, no more than about 70 MPa, no more than about 60 MPa, no more than about 50 MPa, no more than about 40 MPa, no more than about 30 MPa, or no more than about 20 MPa. Combinations of the above-referenced moduli of elasticity are also possible (e.g., at least about 10 MPa and no more than about 500 GPa or at least about 500 MPa and no more than about 1 GPa), inclusive of all values and ranges therebetween. In some embodiments, the structural members 630 can have a modulus of elasticity of about 10 MPa, about 20 MPa, about 30 MPa, about 40 MPa, about 50 MPa, about 60 MPa, about 70 MPa, about 80 MPa, about 90 MPa, about 100 MPa, about 200 MPa, about 300 MPa, about 400 MPa, about 500 MPa, about 600 MPa, about 700 MPa, about 800 MPa, about 900 MPa, about 1 GPa, about 2 GPa, about 3 GPa, about 4 GPa, about 5 GPa, about 6 GPa, about 7 GPa, about 8 GPa, about 9 GPa, about 10 GPa, about 50 GPa, about 100 GPa, about 200 GPa, about 300 GPa, about 400 GPa, or about 500 GPa.

In some embodiments, the pressure in the structural members 630 can be static. In some embodiments, the pressure in the structural members 630 can be actively modulated and dynamic (e.g., via a controller). In some embodiments, the structural members 630 can include valves to regulate inflow and/or outflow of fluid. A higher pressure in the structural members 630 creates a higher pressure in the electrochemical cell stack 610 and lower cell resistance. Lower pressure in the structural members 630 creates a lower pressure in the electrochemical cell stack 610 and a higher cell resistance. In some embodiments, the pressure in the structural members 630 can be adjusted over the lifetime of the electrochemical cell stack 610 based on changes in the thickness of the electrochemical cells 610a, 610b over time.

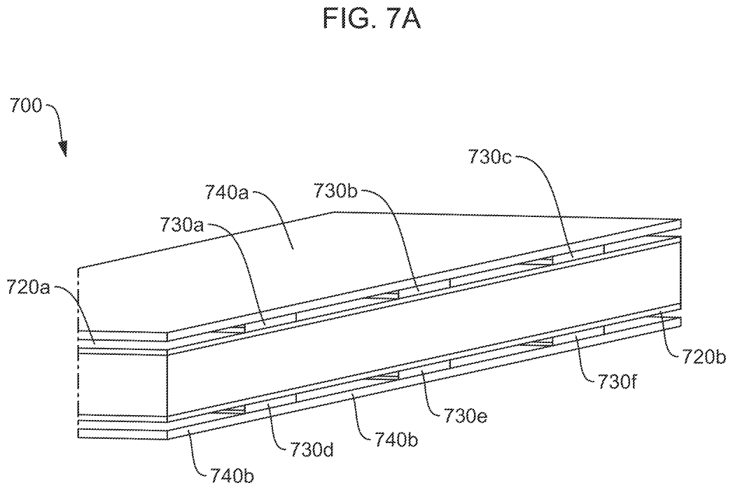

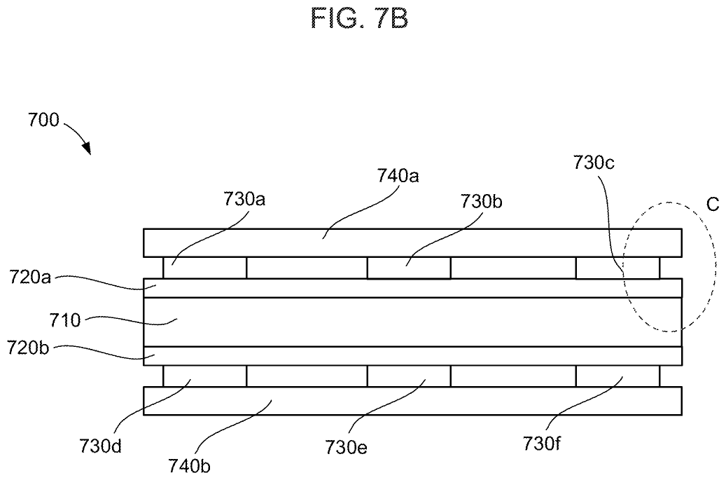

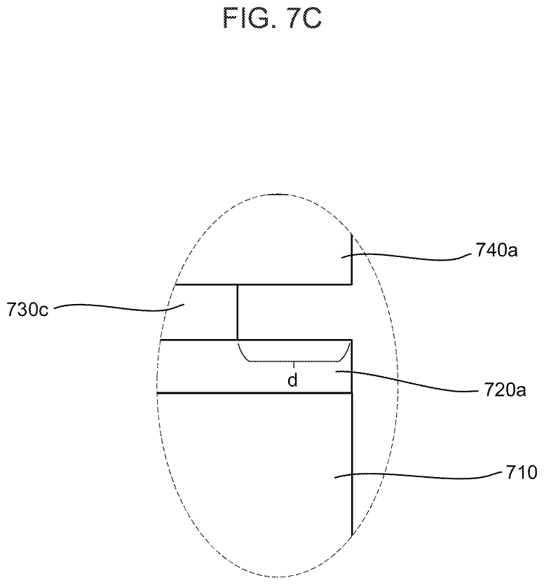

FIGS. 7A-7C are illustrations of an electrochemical cell assembly 700, according to an embodiment. As shown, the electrochemical cell assembly 700 includes an electrochemical cell stack 710, planar sheets 720a, 720b (collectively referred to as planar sheets 720), structural members 730a, 730b, 730c, 730d, 730e, 730f (collectively referred to as structural members 730), and containment structures 740a, 740b (collectively referred to as containment structures 740). In some embodiments, the electrochemical cell stack 710, the planar sheets 720, the structural members 730, and the containment structures 740 can be the same or substantially similar to the electrochemical cell stack 110, the planar sheets 120, the structural members 130, and the containment structure 140, as described above with reference to FIG. 1. Thus, certain aspects of the electrochemical cell stack 710, the planar sheets 720, the structural members 730, and the containment structures 740 are not described in greater detail herein. FIG. 7A shows a perspective view of the electrochemical cell assembly 700. FIG. 7B shows a cross-sectional view of the electrochemical cell assembly 700 and FIG. 7C shows an up-close view of a side of the electrochemical cell assembly 700.

As shown, the structural members 730 are designed as ribs that extend along the width of the containment structures 740. The rib structure can control deformation of the electrochemical cells in the electrochemical cell stack 710. As shown, the electrochemical cell system 700 includes 3 structural members 730 on either side. In some embodiments, the electrochemical cell system 700 can include about 1, about 2, about 3, about 4, about 5, about 6, about 7, about 8, about 9, about 10, about 15, about 20, about 25, about 30, about 35, about 40, about 45, or about 50 structural members 730 on either side, inclusive of all values and ranges therebetween. In some embodiments, the structural members 730 can each be composed of the same material. In some embodiments, the structural members 730 can be composed of varying materials. In some embodiments, the structural members 730 can be composed of a lighter material than the planar sheets 720 and/or the containment structures 740 to reduce the weight of the electrochemical cell assembly 700. In some embodiments, the structural members 730 can be composed of fiberglass, polymer, carbon fiber, metal, aluminum, or any combination thereof. In some embodiments, the structural members 730 can be composed of a material with a modulus of elasticity greater than or equal to that of structural steel.

As shown, the edge of the structural member 730c (and the edges of the other outside structural members 730) is recessed from the edge of the planar sheet 720a and the containment structure 740a by a distance d. In some embodiments, the distance d can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the distance d can be no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm.

In some embodiments, the structural members 730 can each have the same or substantially similar lengths. In some embodiments, the structural members 730 can have differing lengths to evenly distribute pressure throughout the planar sheets 720. In some embodiments, the lengths of the structural members 730 can be optimized via finite element analysis (FEA) simulations. Force along the planar sheets 720 can be retained by compressing and welding the containment structures 740 to the structural members 730 and/or by compressing and welding the structural members 730 to the planar sheets 720. In some embodiments, the structural members 730 can be concave, such that pressure is evenly distributed across the planar sheets 720. More specifically, the containment structure 740 can bend toward the structural member 730 to apply enough uniform pressure on the planar sheet 720 and then from planar sheet 720 to the electrochemical cell stack 710.

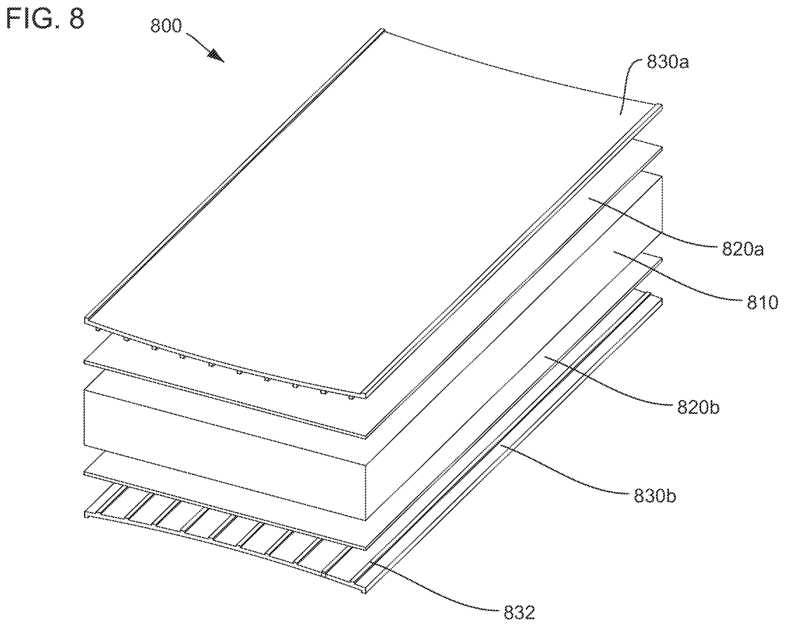

FIG. 8 is an illustration of an electrochemical cell assembly 800, according to an embodiment. As shown, the electrochemical cell assembly 800 includes an electrochemical cell stack 810, planar sheets 820a, 820b (collectively referred to as planar sheets 820), structural members 830a, 830b (collectively referred to as structural members 830) with nubs 832. In some embodiments, the electrochemical cell stack 810, the planar sheets 820, the structural members 830, and the nubs 832 can be the same or substantially similar to the electrochemical cell stack 410, the planar sheets 420, the structural members 430, and the nubs 432, as described above with reference to FIGS. 4A-4B. Thus, certain aspects of the electrochemical cell stack 810, the planar sheets 820, the structural members 830, and the nubs 832 are not described in greater detail herein.

As shown, the structural members 830 include steel nub plates. In some embodiments, the structural members 830 can be composed of 1095 steel. The structural members 830 have a total thickness that includes a base thickness of the steel plates and a thickness of the nubs. In some embodiments, the base thickness of the structural members 830 can be at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the base thickness of the structural members 830 can be no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced thicknesses are also possible (e.g., at least about 1 mm and no more than about 1 cm or at least about 3 mm and no more than about 8 mm), inclusive of all values and ranges therebetween. In some embodiments, the base thickness of the structural members 830 can be about 1 mm, about 2 mm, about 3 mm, about 4 mm, about 5 mm, about 6 mm, about 7 mm, about 8 mm, about 9 mm, or about 1 cm.

In some embodiments, the thickness of the nubs 832 can be at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the thickness of the nubs 832 can be no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced thicknesses are also possible (e.g., at least about 1 mm and no more than about 1 cm or at least about 3 mm and no more than about 8 mm), inclusive of all values and ranges therebetween. In some embodiments, the thickness of the nubs 832 can be about 1 mm, about 2 mm, about 3 mm, about 4 mm, about 5 mm, about 6 mm, about 7 mm, about 8 mm, about 9 mm, or about 1 cm.

In some embodiments, the planar sheets 820 can have a thickness of at least about 500 μm, at least about 1 mm, at least about 1.5 mm, at least about 2 mm, at least about 2.5 mm, at least about 3 mm, at least about 3.5 mm, at least about 4 mm, or at least about 4.5 mm. In some embodiments, the planar sheets 820 can have a thickness of no more than about 5 mm, no more than about 4.5 mm, no more than about 4 mm, no more than about 3.5 mm, no more than about 3 mm, no more than about 2.5 mm, no more than about 2 mm, no more than about 1.5 mm, or no more than about 1 mm. Combinations of the above-referenced thicknesses are also possible (e.g., at least about 500 μm and no more than about 5 mm or at least about 2 mm and no more than about 4 mm), inclusive of all values and ranges therebetween. In some embodiments, the planar sheets 820 can have a thickness of at least about 500 μm, about 1 mm, about 1.5 mm, about 2 mm, about 2.5 mm, about 3 mm, about 3.5 mm, about 4 mm, about 4.5 mm, or about 5 mm.

In some embodiments, the electrochemical cell stack 810 can have a thickness of at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, or at least about 19 cm. In some embodiments, the electrochemical cell stack 810 can have a thickness of no more than about 20 cm, no more than about 19 cm, no more than about 18 cm, no more than about 17 cm, no more than about 16 cm, no more than about 15 cm, no more than about 14 cm, no more than about 13 cm, no more than about 12 cm, no more than about 11 cm, no more than about 10 cm, no more than about 9 cm, no more than about 8 cm, no more than about 7 cm, no more than about 6 cm, no more than about 5 cm, no more than about 4 cm, no more than about 3 cm, or no more than about 2 cm. Combinations of the above-referenced thicknesses are also possible (e.g., at least about 1 cm and no more than about 20 cm or at least about 5 cm and no more than about 15 cm), inclusive of all values and ranges therebetween. In some embodiments, the electrochemical cell stack 810 can have a thickness of about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, or about 20 cm.

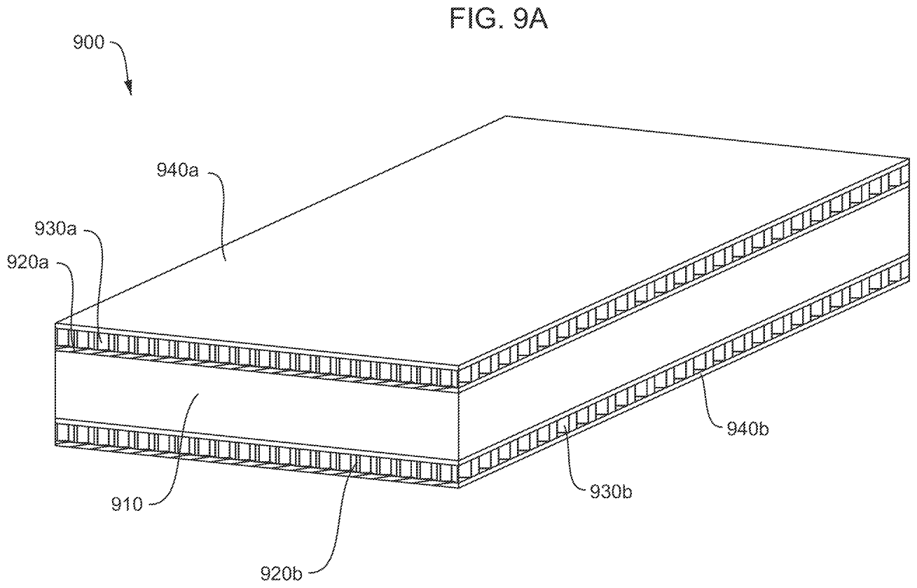

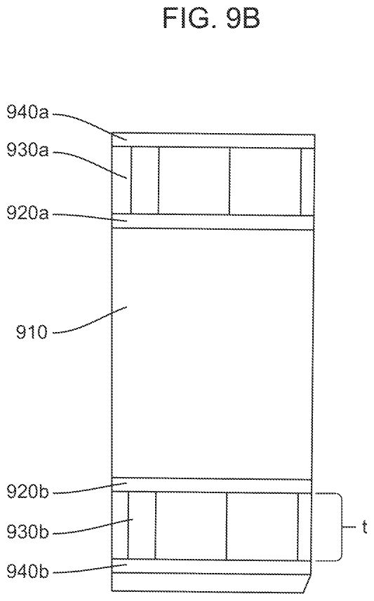

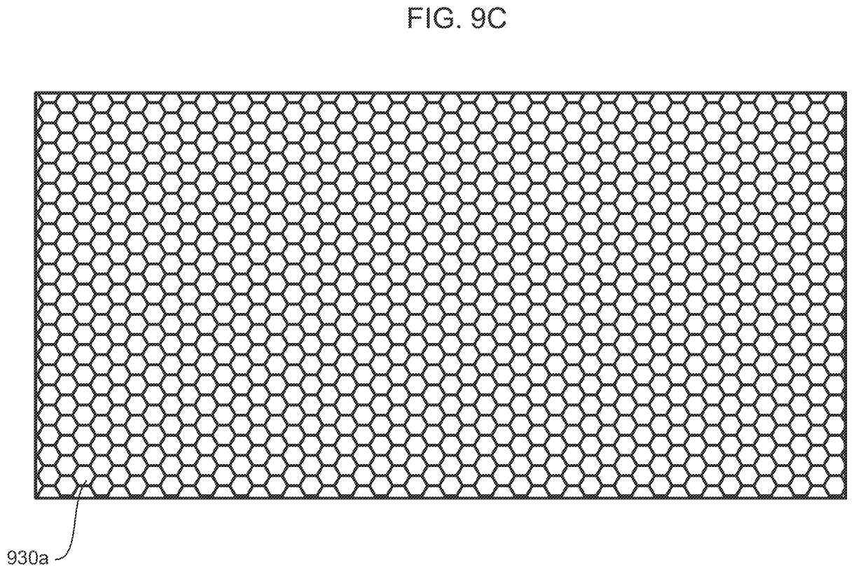

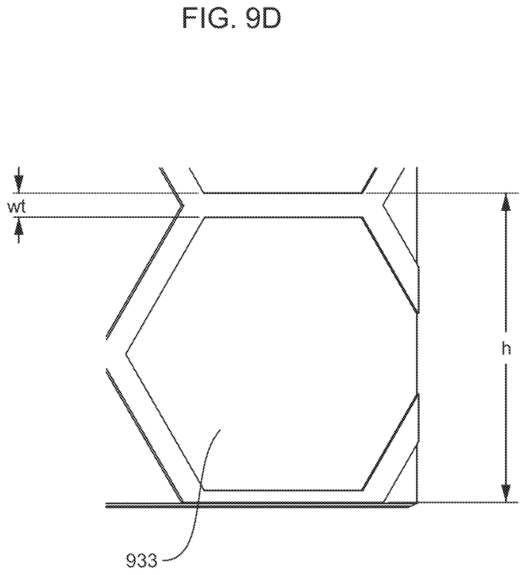

FIGS. 9A-9D are illustrations of an electrochemical cell assembly 900, according to an embodiment. As shown, the electrochemical cell assembly 900 includes an electrochemical cell stack 910, planar sheets 920a, 920b (collectively referred to as planar sheets 920), structural members 930a, 930b (collectively referred to as structural members 930), and containment structures 940a, 940b (collectively referred to as containment structures 940). As shown, the structural members 930 have a honeycomb structure that includes honeycomb cells 933. In some embodiments, the structural members 930 can have a skin adhered to each side of the honeycomb structure. The combination of the skin and the structural members 930 can provide very high stiffness. In some embodiments, the electrochemical cell stack 910, the planar sheets 920, the structural members 930, and the containment structures 940 can be the same or substantially similar to the electrochemical cell stack 110, the planar sheets 120, the structural members 130, and the containment structures 140, as described above with reference to FIG. 1. Thus, certain aspects of the electrochemical cell stack 910, the planar sheets 920, the structural members 930, and the containment structures 940 are not described in greater detail herein. FIG. 9A shows a perspective view of the electrochemical cell assembly 900. FIG. 9B shows a cross-sectional view of a portion of the electrochemical cell assembly 900. FIG. 9C shows the structural member 930a. FIG. 9D shows a single honeycomb cell 933 from the structural member 930a.

In some embodiments, the structural members 930 can be adhered to the planar sheets 920. The honeycomb structure of the structural members 930 can aid in uniform distribution of force throughout the planar sheets 920. In some embodiments, force on the planar sheets 920 can be retained by compressing and/or welding the containment structures 940 to the planar sheets 920. In some embodiments, the electrochemical cell stack 910, the structural members 930, and the containment structures 940 can form a single assembly. For example, each component can be glued together to function as a single structure. They are all glued together and work as one structure.

As shown, the structural members 930 have a thickness t. In some embodiments, the thickness t can be at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 11 mm, at least about 12 mm, at least about 13 mm, at least about 14 mm, at least about 15 mm, at least about 16 mm, at least about 17 mm, at least about 18 mm, or at least about 19 mm. In some embodiments, the thickness t can be no more than about 20 mm, no more than about 19 mm, no more than about 18 mm, no more than about 17 mm, no more than about 16 mm, no more than about 15 mm, no more than about 14 mm, no more than about 13 mm, no more than about 12 mm, no more than about 11 mm, no more than about 10 mm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced thicknesses are also possible (e.g., at least about 1 mm and no more than about 20 mm or at least about 5 mm and no more than about 15 mm), inclusive of all values and ranges therebetween. In some embodiments, the thickness t can be about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, or about 20 mm.

As shown, the honeycomb cell has a wall thickness wt and a height h. In some embodiments, the wall thickness wt can be at least about 100 μm, at least about 150 μm, at least about 200 μm, at least about 300 μm, at least about 400 μm, at least about 500 μm, at least about 1 mm, at least about 1.5 mm, at least about 2 mm, at least about 2.5 mm, at least about 3 mm, at least about 3.5 mm, at least about 4 mm, or at least about 4.5 mm. In some embodiments, the wall thickness wt can be no more than about 5 mm, no more than about 4.5 mm, no more than about 5 mm, no more than about 3.5 mm, no more than about 3 mm, no more than about 2.5 mm, no more than about 2 mm, no more than about 1.5 mm, no more than about 1 mm, no more than about 500 μm, no more than about 400 μm, no more than about 300 μm, no more than about 200 μm, or no more than about 150 μm. Combinations of the above-referenced wall thicknesses wt are also possible (e.g., at least about 500 μm and no more than about 5 mm or at least about 2 mm and no more than about 5 mm), inclusive of all values and ranges therebetween. In some embodiments, the wall thickness wt can be about 100 μm, 150 μm, 200 μm, 300 μm, 400 μm, 500 μm, about 1 mm, about 1.5 mm, about 2 mm, about 2.5 mm, about 3 mm, about 3.5 mm, about 4 mm, about 4.5 mm, or about 5 mm.

In some embodiments, the height h can be at least about 5 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the height h can be no more than about 5 cm, no more than about 4.5 cm, no more than about 4 cm, no more than about 3.5 cm, no more than about 3 cm, no more than about 2.5 cm, no more than about 2 cm, no more than about 1.5 cm, or no more than about 1 cm. Combinations of the above-referenced heights h are also possible (e.g., at least about 5 mm and no more than about 5 cm or at least about 2 cm and no more than about 4 cm), inclusive of all values and ranges therebetween. In some embodiments, the height h can be about 5 mm, about 1 cm, about 1.5 cm, about 2 cm, about 2.5 cm, about 3 cm, about 3.5 cm, about 4 cm, about 4.5 cm, or about 5 cm.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell assembly, comprising:
a plurality of electrochemical cells arranged in a stack;
a first planar sheet in contact with a first side of the stack;
a second planar sheet in contact with a second side of the stack;
a first structural member in compressive contact with the first planar sheet; and
a second structural member in compressive contact with the second planar sheet,
wherein the compressive contact between the first structural member and the first planar sheet and the compressive contact between the second structural member and the second planar sheet collectively provide structural rigidity to the electrochemical cell assembly.

2. The electrochemical cell assembly of claim 1, wherein the first structural member and the second structural member include pressure plates with nubs configured to impart a compressive force on the first planar sheet and the second planar sheet.

3. The electrochemical cell assembly of claim 2, wherein the nubs have a first length at a location near a horizontal center of the electrochemical cell stack and a second length at a location near a horizontal edge of the electrochemical cell stack, the first length greater than the second length.

4. The electrochemical cell assembly of claim 3, further comprising a clamp configured to impart a compressive force on the first structural member and the second structural member.

5. The electrochemical cell assembly of claim 1, wherein the stack has a length-to-thickness aspect ratio of at least about 100.

6. The electrochemical cell assembly of claim 1, wherein the first structural member and the second structural member each include leaf springs configured to apply a compressive force to the first planar sheet and the second planar sheet.

7. The electrochemical cell assembly of claim 1, further comprising a containment structure configured to contain the structural member.

8. The electrochemical cell assembly of claim 1, wherein the first structural member and the second structural member each include an inflatable bladder.

9. The electrochemical cell assembly of claim 1, wherein the stack of electrochemical cells has a length-to-thickness aspect ratio of at least about 20.

10. A method of forming an electrochemical cell assembly, the method comprising:
stacking a plurality of electrochemical cells to form an electrochemical cell stack;
disposing a first planar structure on a first side of the electrochemical cell stack;
disposing a second planar structure on a second side of the electrochemical cell stack, the second side opposite the first side;
disposing a first structural member on the first planar structure; and
disposing a second structural member on the second planar structure to form the electrochemical cell assembly,
wherein the first structural member imparts a force on the first planar structure and the second structural member imparts a force on the second planar structure.

11. The method of claim 10, further comprising:
disposing the plurality of electrochemical cells, the first planar structure, the second planar structure, the first structural member, and the second structural member in a containment structure, wherein the containment structure imparts a force on the first structural member and the second structural member such that the first structural member imparts a force on the first planar structure and the second structural member imparts a force on the second planar structure.

12. The method of claim 10, wherein the first structural member and the second structural member each include a plurality of nubs, the plurality of nubs having a first length near a horizontal center of the electrochemical cell stack and a second length near a horizontal edge of the electrochemical cell stack, the first length greater than the second length.

13. The method of claim 10, wherein the first structural member and the second structural member each include a leaf spring.

14. The method of claim 10, wherein the first structural member and the second structural member each include inflatable members.

15. The method of claim 14, further comprising:
disposing the plurality of electrochemical cells, the first planar structure, the second planar structure, the first structural member, and the second structural member in a containment structure; and
inflating the first structural member and the second structural member.

16. The method of claim 10, wherein the electrochemical cell stack has an aspect ratio of at least about 20:1.

17. An electrochemical cell assembly, comprising:
a plurality of electrochemical cells arranged in a stack of electrochemical cells;
a planar structure disposed on the stack of electrochemical cells; and
a structural member disposed on the planar structure, the structural member including at least one of a leaf spring, an inflatable member, a stiffener rib, a planar sheet including a plurality of nubs, or a sheet of material formed into a honeycomb structure;
wherein the structural member is configured to apply a compressive force to the planar structure.

18. The electrochemical cell assembly of claim 17, wherein the stack of electrochemical cells has an aspect ratio of at least about 20:1.

19. The electrochemical cell assembly of claim 17, further comprising:
a containment structure configured to contain and contact the structural member.

20. The electrochemical cell assembly of claim 19, wherein the structural member includes a planar sheet including a plurality of nubs, and the containment structure includes a clamp configured to clamp the planar sheet, such that the nubs of the planar sheet contact the planar structure.

21. The electrochemical cell assembly of claim 20, wherein the plurality of nubs have a first length near a horizontal center of the stack of electrochemical cells and a second length near a horizontal edge of the electrochemical cell stack, the first length greater than the second length.

22. The electrochemical cell assembly of claim 20, wherein the structural member includes a plurality of leaf springs, the plurality of leaf springs being in a relaxed state while in curved orientation and under tension while in a straight orientation.

23. The electrochemical cell assembly of claim 17, wherein the structural member includes an inflatable member, the electrochemical cell assembly further comprising:
a containment structure configured to house the stack of electrochemical cells, the planar structure, and the structural member, the containment structure having a higher modulus of elasticity than the structural member.
